(19) United States
(12) Patent Application Publication
(10) Pub. No.: US 2014/0229700 A1
(43) Pub. Date: Aug. 14, 2014

(54) Systems and Methods for Accommodating End of Transfer Request in a Data Storage Device

(71) Applicant: LSI CORPORATION, Milpitas, CA (US)

(72) Inventors: Shaohua Yang, San Jose, CA (US); Fan Zhang, Milpitas, CA (US); Kaitlyn T. Nguyen, San Jose, CA (US)

(73) Assignee: LSI Corporation, Milpitas, CA (US)

(21) Appl. No.: 13/766,857

(22) Filed: Feb. 14, 2013

(51) Int. Cl. G06F 3/06

(52) U.S. Cl. CPC G06F 3/0611
USPC 711/167

(57) ABSTRACT

Systems and methods for data processing particularly related addressing latency concerns in relation to data processing.

### BACKGROUND

Embodiments are related to systems and methods for accessing data sets, and more particularly to systems and methods for governing latency in a data set access.

Various data transfer systems have been developed that allow for accessing data sets. In such systems data is requested, and the requested data is produced to the requestor. There is generally some latency between when the data is requested and when it is finally provided to the requestor. In some cases, this latency becomes so significant that it results in errors in the requestor.

Hence, for at least the aforementioned reasons, there exists a need in the art for advanced systems and methods for governing latency during a data request.

### BRIEF SUMMARY

Embodiments are related to systems and methods for accessing data sets, and more particularly to systems and methods for governing latency in a data set access.

Some embodiments of the present invention provide methods for data processing. The methods include receiving a request for a block of data sets. The block of data sets includes at least a first data set and a second data set. The methods further include: storing the first data set to an input buffer; storing the second data set to the input buffer; and determining a remaining portion (ELB) of an end of burst latency (EOB) allowable for processing the block of data sets. The methods include scheduling processing of the first data set by a data processing circuit. In particular, such scheduling is done according to a first scheduling algorithm based at least in part on the ELB being less than a threshold. Alternatively, such scheduling is done according to a second scheduling algorithm when the ELB is greater than the threshold.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phases do not necessarily refer to the same embodiment. Many other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a shows a data processing circuit including a latency based decoder scheduling circuit in accordance with some embodiments of the present invention;

FIGS. 1b-1c are timing diagrams showing an example operation of the data processing circuit of FIG. 1a used to demonstrate the concepts of per sector latency and end of burst latency;

FIGS. 2a-2d are flow diagrams showing a method for data processing including latency based decoder scheduling in accordance with some embodiments of the present invention; and

FIG. 3 shows a storage system including a latency governing circuit in accordance with various embodiments of the present invention.

### DETAILED DESCRIPTION

Embodiments are related to systems and methods for accessing data sets, and more particularly to systems and methods for governing latency in a data set access.

Some embodiments of the present invention provide methods for data processing. The methods include receiving a request for a block of data sets. The block of data sets includes at least a first data set and a second data set. The methods further include: storing the first data set to an input buffer; storing the second data set to the input buffer; and determining a remaining portion (ELB) of an end of burst latency (EOB) allowable for processing the block of data sets. The methods include scheduling processing of the first data set by a data processing cirucit. In particular, such scheduling is done according to a first scheduling algorithm based at least in part on the ELB being less than a threshold. Alternatively, such scheduling is done according to a second scheduling algorithm when the ELB is greater than the threshold. In one or more instances of the aforementioned embodiments, scheduling processing of the first data set by a data processing circuit according to the first scheduling algorithm is done when the ELB is less than the threshold and an output buffer is ready to transfer a data set to a requester.

In some instances of the aforementioned embodiments, the threshold is a first threshold, and the ELB is a first ELB. In such instances, the methods further include: determining a second ELB of the EOB; scheduling processing of the second data set by the data processing circuit according to the first scheduling algorithm when the second ELB is less than a second threshold; and scheduling processing of the first data set by the data processing circuit according to a second scheduling algorithm when the second ELB is greater than the second threshold.

In various instances of the aforementioned embodiments, the methods further include: accessing a representation of the first data set from a storage medium; and accessing a representation of the second data set from the storage medium. A first period required to access the first data set from the storage medium is a sector time, and a second period required to access the second data set from the storage medium is the sector time. In some cases, determining the ELB is done by subtracting a number of sector times passed from when the first data set is accessed from the storage medium from the EOB.

In one or more instances of the aforementioned embodiments, the threshold is a number of data sets maintained in the input buffer. In various instances of the aforementioned embodiments, the threshold is the aggregate of a number of data sets maintained in the input buffer being initially processed through the data processing circuit and a number of data sets maintained in the input buffer awaiting retry processing through the data processing circuit plus a fixed amount. In some such cases, the data processing circuit includes: a data detector circuit operable to apply a data detection algorithm to yield a detected output; and a data decoder circuit operable to apply a data decode algorithm to a decoder input derived from the detected output. In particular cases, the first scheduling algorithm terminates processing of the first data set upon completion of application of the data decode algorithm regardless of whether another iteration through both the data detector circuit and data decoder circuit would be allowed for the first data set if the second scheduling algorithm was used for scheduling.

Other embodiments of the present invention provide systems for data processing that include: an input buffer, a data detector circuit, a data decoder circuit, and a scheduling circuit. The input buffer is operable to maintain a first data set and a second data set. The data detector circuit is operable to: apply a data detection algorithm to the first data set to yield a first detected output, and apply the data detection algorithm to the second data set to yield a second detected output. The data decoder circuit is operable to: apply a data decode algorithm to a first decoder input derived from the first detected output to yield a first decoder output, and apply the data decode algorithm to a second decoder input derived from the second detected output to yield a second decoder output. The scheduling circuit is operable to: determine a remaining portion (ELB) of an end of burst latency value; scheduling processing of the first data set by the data decoder circuit according to a first scheduling algorithm based at least in part on the ELB being less than a threshold; and scheduling processing of the first data set by the data decoder circuit according to a second scheduling algorithm when the ELB is greater than the threshold. In some instances of the aforementioned embodiments, the system is implemented as part of an integrated circuit. In various instances of the aforementioned embodiments, the systems further include an output buffer operable to transfer a result from the data decoder circuit to a recipient. In such instances, scheduling processing of the first data set by a data processing circuit according to the first scheduling algorithm is done when the ELB is less than the threshold and the output buffer has one or fewer results from the decoder circuit awaiting transfer to the recipient.

In some instances of the aforementioned embodiments, the system is implemented as part of a data storage device. The systems further include: a storage medium maintaining a representation of the first data set and the second data set, and an access circuit. The access circuit is operable to: access the representation of the first data set and the representation of the second data set from the storage medium, and store the first data set and the second data set to the input buffer. A first period required to access the representation of the first data set from the storage medium is a sector time, and a second period required to access the representation of the second data set from the storage medium is the sector time. The end of burst latency value is a maximum number of sector times allowable from when a last portion of a data block is accessed from the storage medium until the last portion is provided as an output. The data block includes both the first data set and the second data set. In some cases, determining the ELB is done by subtracting a number of sector times passed from when the representation of the first data set is accessed from the storage medium from the end of burst latency value.

In various instances of the aforementioned embodiments, the threshold is a number of data sets maintained in the input buffer. In some instances of the aforementioned embodiments, the threshold is the aggregate of a number of data sets maintained in the input buffer being initially processed through the data processing circuit and a number of data sets maintained in the input buffer awaiting retry processing through the data processing circuit plus a fixed amount. In some such instances, the first scheduling algorithm terminates processing of the first data set upon completion of application of the data decode algorithm regardless of whether another iteration through both the data detector circuit and data decoder circuit would be allowed for the first data set if the second scheduling algorithm was used for scheduling. In one particular case where the data decoder is operable to process four data sets per sector time, the fixed amount is 1.25.

Iterative data processing systems may include a data detector circuit that applies a data detection algorithm to a data set to yield a detected output and a data decoder circuit that applies a data decoding algorithm to a decoder input derived from the detected output to yield a decoded output. The process of passing data through both the data detector circuit and the data decoder circuit is referred to herein as a “global iteration”. During each global iteration, the data decoding algorithm may be repeatedly applied to a processing data set. This reapplication of the data decoding algorithm is referred to herein as a “local iteration”. In particular embodiments of the present invention, a default number of ten local iterations are allowed for each global iteration. Based upon the disclosure provided herein, one of ordinary skill in the art will recognize a variety of numbers of local iterations that may be used as a default in relation to different embodiments of the present invention.

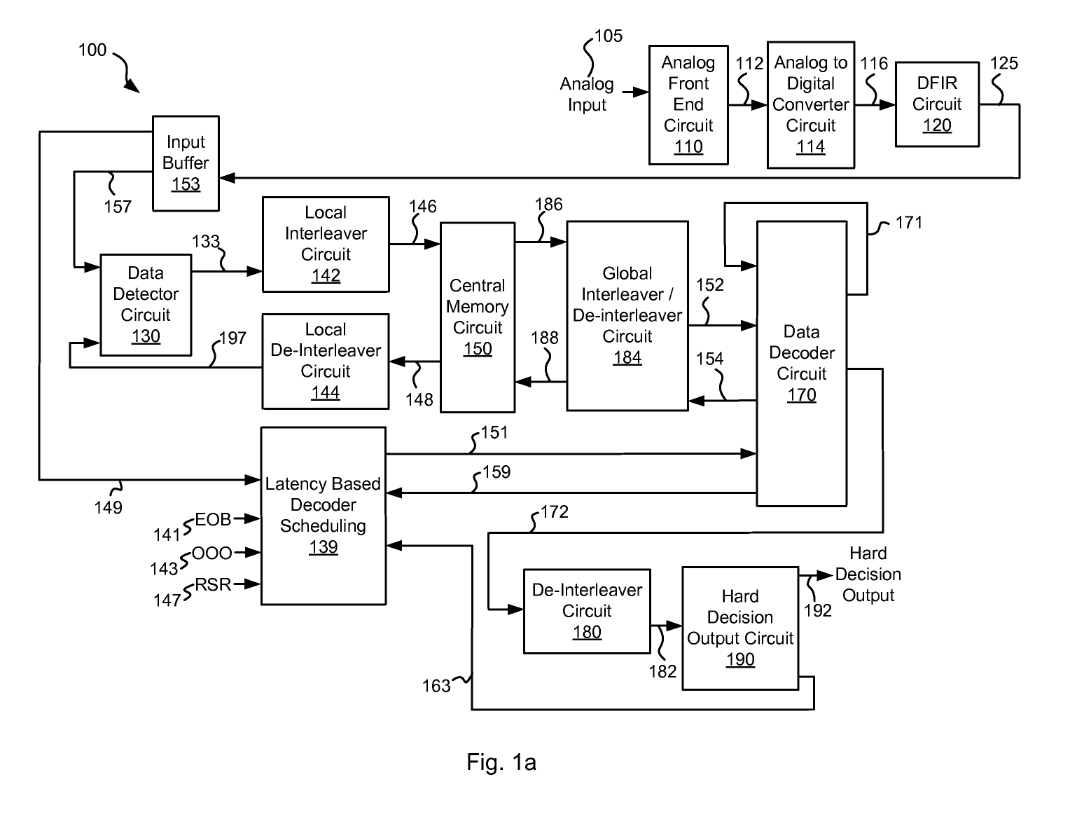

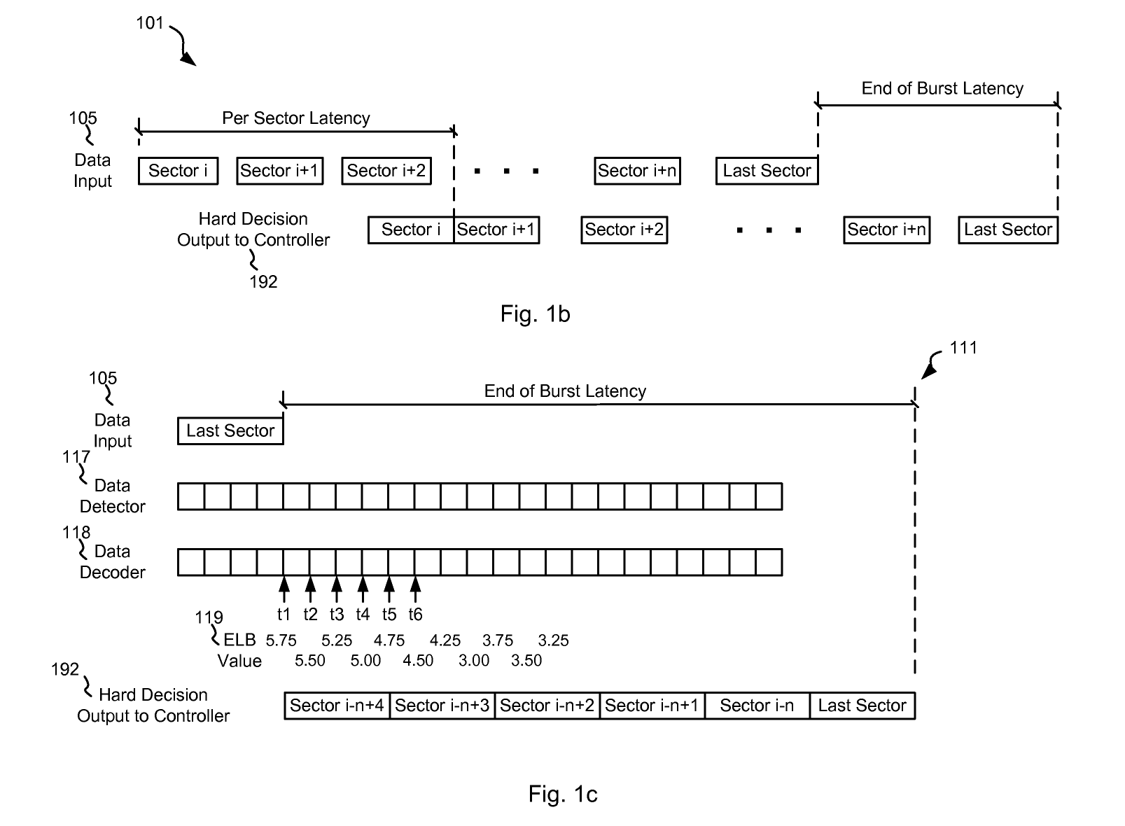

Some iterative data processing circuits allow for data sets to be reported to a requesting device in an order different from the order in which processing on the data sets begins. Such “out of order” processing allows more flexibility in processing and at times results in an ability to apply more processing bandwidth to problematic data sets. In some cases, such out of order processing increases the complexity of the data processing systems. The details of such out of order processing are available in the prior art and are not provided herein, but the occurrence of out of order processing is indicated by assertion of an “OOO” input as described below in relation to FIG. 1a.

One or more iterative data processing circuits allow for retaining a data set that has not completed processing within a limited amount of processing for further processing during a slow processing period. Such an approach is referred to herein as “retained sector reprocessing” and allow for additional processing bandwidth to be applied to one or more particularly difficult data sets that fail to converge within the limited processing allowed to all data sets. The additional processing is applied at times when excess processing bandwidth is expected to be available such as, for example, during a track change when reading from a storage medium. This additional processing can result in the convergence of one or more data sets that may have otherwise not converged. The details of such retained sector reprocessing are available in the prior art and are not provided herein, but the occurrence of retained sector reprocessing is indicated by assertion of an “RSR” input as described below in relation to FIG. 1a.

Turning to FIG. 1a, a data processing circuit 100 including a latency based decoder scheduling circuit 139 is shown in accordance with some embodiments of the present invention. Data processing circuit 100 includes an analog front end circuit 110 that receives an analog signal 105. Analog front end circuit 110 processes analog signal 105 and provides a processed analog signal 112 to an analog to digital converter circuit 114. Analog front end circuit 110 may include, but is not limited to, an analog filter and an amplifier circuit as are known in the art. Based upon the disclosure provided herein, one of ordinary skill in the art will recognize a variety of circuitry that may be included as part of analog front end circuit 110. In some cases, analog signal 105 is derived from a read/write head assembly (not shown) that is disposed in relation to a storage medium (not shown). In other cases, analog signal 105 is derived from a receiver circuit (not shown) that is operable to receive a signal from a transmission medium (not shown). The transmission medium may be wired or wireless. Based upon the disclosure provided herein, one of ordinary skill in the art will recognize a variety of source from which analog input 105 may be derived.

Analog to digital converter circuit 114 converts processed analog signal 112 into a corresponding series of digital samples 116. Analog to digital converter circuit 114 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 116 are provided to an equalizer circuit 120. Equalizer circuit 120 applies an equalization algorithm to digital samples 116 to yield an equalized output 125. In some embodiments of the present invention, equalizer circuit 120 is a digital finite impulse response filter circuit as are known in the art. It may be possible that equalized output 125 may be received directly from a storage device in, for example, a solid state storage system. In such cases, analog front end circuit 110, analog to digital converter circuit 114 and equalizer circuit 120 may be eliminated where the data is received as a digital data input. Equalized output 125 is stored to an input buffer 153 that includes sufficient memory to maintain one or more codewords until processing of that codeword is completed through a data detector circuit 130 and a data decoding circuit 170 including, where warranted, multiple global iterations (passes through both data detector circuit 130 and data decoding circuit 170) and/or local iterations (passes through data decoding circuit 170 during a given global iteration). An output 157 is provided to data detector circuit 130.

Data detector circuit 130 may be a single data detector circuit or may be two or more data detector circuits operating in parallel on different codewords. Whether it is a single data detector circuit or a number of data detector circuits operating in parallel, data detector circuit 130 is operable to apply a data detection algorithm to a received codeword or data set. In some embodiments of the present invention, data detector circuit 130 is a Viterbi algorithm data detector circuit as are known in the art. In other embodiments of the present invention, data detector circuit 130 is a is a maximum a posteriori data detector circuit as are known in the art. Of note, the general phrases “Viterbi data detection algorithm” or “Viterbi algorithm data detector circuit” are used in their broadest sense to mean any Viterbi detection algorithm or Viterbi algorithm detector circuit or variations thereof including, but not limited to, bi-direction Viterbi detection algorithm or bi-direction Viterbi algorithm detector circuit. Also, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments of the present invention. In some cases, one data detector circuit included in data detector circuit 130 is used to apply the data detection algorithm to the received codeword for a first global iteration applied to the received codeword, and another data detector circuit included in data detector circuit 130 is operable apply the data detection algorithm to the received codeword guided by a decoded output accessed from a central memory circuit 150 on subsequent global iterations.

Upon completion of application of the data detection algorithm to the received codeword on the first global iteration, data detector circuit 130 provides a detector output 133. Detector output 133 includes soft data. As used herein, the phrase “soft data” is used in its broadest sense to mean reliability data with each instance of the reliability data indicating a likelihood that a corresponding bit position or group of bit positions has been correctly detected. In some embodiments of the present invention, the soft data or reliability data is log likelihood ratio data as is known in the art. Detected output 133 is provided to a local interleaver circuit 142. Local interleaver circuit 142 is operable to shuffle sub-portions (i.e., local chunks) of the data set included as detected output and provides an interleaved codeword 146 that is stored to central memory circuit 150. Interleaver circuit 142 may be any circuit known in the art that is capable of shuffling data sets to yield a re-arranged data set. Interleaved codeword 146 is stored to central memory circuit 150.

Once a data decoding circuit 170 is available, a previously stored interleaved codeword 146 is accessed from central memory circuit 150 as a stored codeword 186 and globally interleaved by a global interleaver/de-interleaver circuit 184. Global interleaver/De-interleaver circuit 184 may be any circuit known in the art that is capable of globally rearranging codewords. Global interleaver/De-interleaver circuit 184 provides a decoder input 152 to data decoding circuit 170 that applies a data decoding algorithm to decoder input 152. In some embodiments of the present invention, the data decode algorithm is a low density parity check algorithm as are known in the art. Based upon the disclosure provided herein, one of ordinary skill in the art will recognize other decode algorithms that may be used in relation to different embodiments of the present invention. Data decoding circuit 170 applies a data decode algorithm to decoder input 152 to yield a decoded output 171. In cases where another local iteration (i.e., another pass trough data decoder circuit 170) is desired, data decoding circuit 170 re-applies the data decode algorithm to decoder input 152 guided by decoded output 171. This continues until either a maximum number of local iterations is exceeded or decoded output 171 converges.

Where decoded output 171 fails to converge (i.e., fails to yield the originally written data set) and a number of local iterations through data decoding circuit 170 exceeds the maximum number of local iterations, the resulting decoded output is provided as a decoded output 154 back to central memory circuit 150 where it is stored awaiting another global iteration through a data detector circuit included in data detector circuit 130. Prior to storage of decoded output 154 to central memory circuit 150, decoded output 154 is globally de-interleaved to yield a globally de-interleaved output 188 that is stored to central memory circuit 150. The global de-interleaving reverses the global interleaving earlier applied to stored codeword 186 to yield decoder input 152. When a data detector circuit included in data detector circuit 130 becomes available, a previously stored de-interleaved output 188 accessed from central memory circuit 150 and locally de-interleaved by a de-interleaver circuit 144. De-interleaver circuit 144 rearranges decoder output 148 to reverse the shuffling originally performed by interleaver circuit 142. A resulting de-interleaved output 197 is provided to data detector circuit 130 where it is used to guide subsequent detection of a corresponding data set previously received as equalized output 125.

Alternatively, where the decoded output converges (i.e., yields the originally written data set), the resulting decoded output is provided as an output codeword 172 to a de-interleaver circuit 180. De-interleaver circuit 180 rearranges the data to reverse both the global and local interleaving applied to the data to yield a de-interleaved output 182. De-interleaved output 182 is provided to a hard decision output circuit 190. Hard decision output circuit 190 is operable to re-order data sets that may complete out of order back into their original order. The originally ordered data sets are then provided as a hard decision output 192.

Latency based decoder scheduling circuit 139 controls scheduling of data sets processing through data processing circuit 100 based upon a decoder status signal 159, a hard decision output status signal 163, an awaiting processing status signal 149, an end of burst (“EOB”) latency input 141, an out of order (“OOO”) input 143, and a retained sector retry (“RSR”) input 147. Decoder status signal 159 is provided from data decoder circuit 170 and indicates a convergence status of a currently processing data set. Hard decision output status signal 163 is provided from hard decision output circuit 190 and indicates a number of data sets awaiting transfer out of data processing circuit 100 as hard decision outputs 192. Awaiting processing status signal 149 is provided from input buffer 153 and indicates a number of data set currently being processed through data processing circuit 100. OOO input 143 is set by the host controller, and when set indicates that out of order processing is being supported by data processing circuit 100. In contrast, when OOO input 143 is not set by the host controller, in order (“IO”) processing is selected where data sets are expected by the host controller in a requested order. RSR input 147 is controlled by data processing circuit 100 and indicates that one or more data sets failed to converge on a first round of global and local iterations through data processing circuit 100 and have been retained in input buffer 153 for additional processing during a less busy processing period. As such, data processing circuit 100 can support any of the following processing combinations: IO and RSR, OOO and RSR, IO and no RSR, and OOO and no RSR.

EOB latency input 141 is received from a host controller (not shown) and indicates a maximum number of sector times that can occur between accessing a last data set within a block of requested data sets and the last sector provided from data processing circuit 100 as an instance of hard decision output. Turning to FIG. 1b, a timing diagram 101 shows an end of burst latency in comparison with a per sector latency. As shown, per sector latency is a time period between when a data set (e.g., Sector i) is received from as input 105 from a storage medium until the end of the hard decision output corresponding to the received data set is provided by a hard decision output controller 190 as hard decision output 192. Where a variable number of iterations are allowable for each data set, it will be appreciated that the per sector latency may vary from one sector to another. Also as shown, the end of burst latency is measured as a time period between when the last sector or data set in a requested block of data sets is received as data input 105 from a storage medium until the end of the hard decision output corresponding to the last available data set in the requested block of data sets is provided by a hard decision output controller 190 as hard decision output 192. It should be noted that while the “last sector” is shown as the last data set provided as hard decision output 192, where a variable number of iterations may be applied to each of the processing sectors or data sets, another sector may be the last data set provided as a hard decision output to a host device. In this case, the end of burst latency is measured from the last sector received as data input 105 until the last processing data set (the last sector or another sector) is provided as a hard decision output 192.

In some embodiments of the present invention, throughput from data processing circuit 100 to a host controller is on a one sector per sector time basis, however internal processing of data processing circuit 100 can generate results in less than one sector time. As used herein, a “sector time” is the amount of time needed to access one sector of data from a storage medium and provide the sector of data as data input 105. As an example, in one embodiment of the present invention, data decoder circuit 170 can process four sectors of data per sector time. Using this example, because data decoder circuit 170 can provide four sectors of output for each sector time, and hard decision output circuit 190 can only transfer out one sector of data as hard decision output 192 per sector time, it makes sense to allow data decoder circuit 170 to continue processing on some of the currently processing sectors of data as hard decision output circuit 190 would not be able to transfer them out any faster.

In operation, latency based decoder scheduling circuit 139 operates to assure that the latency dictated EOB latency input 141 is enforced, while at the same time, latency based decoder scheduling circuit 139 operates to assure that as many local iterations of the decode algorithm by data decoder circuit 170 are applied. In some cases, latency based decoder scheduling circuit 139 operates to control the maximum per sector latency by assuring data decoder circuit 170 chooses the oldest sector for earlier processing. Latency based decoder scheduling circuit 139 monitors hard decision output status signal 163 and only releases non-converging data sets to hard decision output circuit 190 via de-interleaver circuit 180 when such are needed to assure a pipeline of instances of hard decision output 192 remains sufficiently full to assure that the burst output does not exceed that indicated by EOB latency input 141. To accomplish the aforementioned, latency based decoder scheduling circuit 139 asserts a decoder bypass signal 151 whenever a remaining latency budget indicated by EOB latency input 141 reaches a critical point indicating that a data set to be processed by data decoder circuit 170 is to be completed and the result reported to hard decision output circuit 190 via de-interleaver circuit 180 to be provided as an instance of hard decision output 192 regardless of convergence or a total number of global iterations applied to the data set.

Where either in order (IO) or out of order (OOO) processing is enabled without retained sector reprocessing (RSR) (i.e., RSR input 147 is not asserted), the remaining EOB budget (referred to herein as end of latency budget “ELB” and is represented in sector times) is checked against a number of in flight sectors (NIS) or data sets prior to schedule each run of data decoder circuit 170. The NIS is the number of sectors of data maintained in input buffer 153 and is reported to latency based decoder scheduling circuit 139 as awaiting processing status signal 149. At the beginning of processing of a block of requested data sets (e.g., at the beginning of a track on a storage medium), ELB is larger than NIS. Toward the end of processing the block of requested data sets, ELB approaches and in some cases becomes less than NIS.

When ELB is greater than NIS sector times, scheduling of data decoder circuit 170 is not modified to address concerns dictated by EOB latency input 141 (i.e., decoder bypass signal 151 is de-asserted indicating that data decoder circuit 170 is to continue processing until a maximum number of local iterations have been achieved, and the processing data set is maintained for additional processing where the maximum number of global iterations for the currently processing data set has not yet been exceeded).

Alternatively, when ELB is less than or equal to NIS sector times, it is determined whether hard decision output circuit 190 has only one sector or data set awaiting output as hard decision output 192 as indicated by hard decision output status signal 163. Where only one sector (or less than one sector) awaits output by hard decision output circuit 190 decoder bypass signal 151 is asserted indicating that data decoder circuit 170 is to access the oldest (i.e., the data set exhibiting the largest per sector latency) sector or data set in central memory 150 for application of the data decode algorithm (including all allowable local iterations) and for kickout (i.e., providing the result as output codeword 172) regardless of a total number of global iterations applied and/or convergence. Alternatively, where two or more sectors or data sets await output by hard decision output circuit 190 decoder bypass signal 151 is de-asserted indicating that data decoder circuit 170 is to apply standard processing (indicating that data decoder circuit 170 is to continue processing until a maximum number of local iterations have been achieved, and the processing data set is maintained for additional processing where the maximum number of global iterations for the currently processing data set has not yet been exceeded).

Where either in order (IO) or out of order (OOO) processing is enabled along with retained sector reprocessing (RSR) (i.e., RSR input 147 is asserted), the remaining EOB budget (ELB) is checked against a number of in flight sectors (NIS) or data sets and the number of retained sectors (“NRS”) prior to schedule each run of data decoder circuit 170. Both the NIS and NRS is the number of sectors of data maintained in input buffer 153 and is reported to latency based decoder scheduling circuit 139 as awaiting processing status signal 149. At the beginning of processing of a block of requested data sets (e.g., at the beginning of a track on a storage medium), ELB is larger than NIS+NRS. Toward the end of processing the block of requested data sets, ELB approaches and in some cases becomes less than NIS+NRS.

When ELB is greater than NIS+NRS+1.25 sector times, scheduling of data decoder circuit 170 is not modified to address concerns dictated by EOB latency input 141 (i.e., decoder bypass signal 151 is de-asserted indicating that data decoder circuit 170 is to continue processing until a maximum number of local iterations have been achieved, and the processing data set is maintained for additional processing where the maximum number of global iterations for the currently processing data set has not yet been exceeded).

Alternatively, when ELB is less than or equal to NIS+NRS+1.25 sector times, it is determined whether hard decision output circuit 190 has only one sector or data set awaiting output as hard decision output 192 as indicated by hard decision output status signal 163. Where only one sector (or less than one sector) awaits output by hard decision output circuit 190 decoder bypass signal 151 is asserted indicating that data decoder circuit 170 is to access the oldest (i.e., the data set exhibiting the largest per sector latency) sector or data set in central memory 150 for application of the data decode algorithm (including all allowable local iterations) and for kickout (i.e., providing the result as output codeword 172) regardless of a total number of global iterations applied and/or convergence. Alternatively, where two or more sectors or data sets await output by hard decision output circuit 190 decoder bypass signal 151 is de-asserted indicating that data decoder circuit 170 is to apply standard processing (indicating that data decoder circuit 170 is to continue processing until a maximum number of local iterations have been achieved, and the processing data set is maintained for additional processing where the maximum number of global iterations for the currently processing data set has not yet been exceeded). The addition of 1.25 to NIS+NRS preserves at least one sector time to transfer per retained sector, and the retained sectors are transferred out in one global iteration. In this embodiment, NRS/4 sector times are needed for one global iteration of a retained sector, and one sector time to transfer the result as hard decision output 192 to a requesting host.

Turning to FIG. 1c, a timing diagram 111 shows detail of an example processing from reception of a last sector as data input 105 from a storage device, until the production of a last sector of data as hard decision output 192. As shown, in this example the end of burst latency is six (6) sector times (i.e., the length of the last sector received as data input 105). As shown, a data detector circuit processing 117 by data detector circuit 130 takes one quarter of one sector time, and a data decoder processing 118 by data decoder circuit 170 takes one quarter of one sector time. As shown, a number of data decoder processing 118 are indicated as t1, t2, t3, t4, t5, t6 indicating a release of a data set for output as hard decision output 192. The sector completing processing at the point indicated as t1 is released when ELB value 119 is equal to 5.75 and produced as an instance (Sector i−n+4) to a host controller; the sector completing processing at the point indicated as t2 is released when ELB value 119 is equal to 5.50 and produced as an instance (Sector i−n+3) to the host controller; the sector completing processing at the point indicated as t3 is released when ELB value 119 is equal to 5.25 and produced as an instance (Sector i−n+2) to the host controller; the sector completing processing at the point indicated as t4 is released when ELB value 119 is equal to 5.00 and produced as an instance (Sector i−n+1) to the host controller; the sector completing processing at the point indicated as t5 is released when ELB value 119 is equal to and produced as an instance (Sector i−n) to the host controller; and the sector completing processing at the point indicated as t6 is released when ELB value 119 is equal to and produced as an instance (Last Sector) to the host controller.

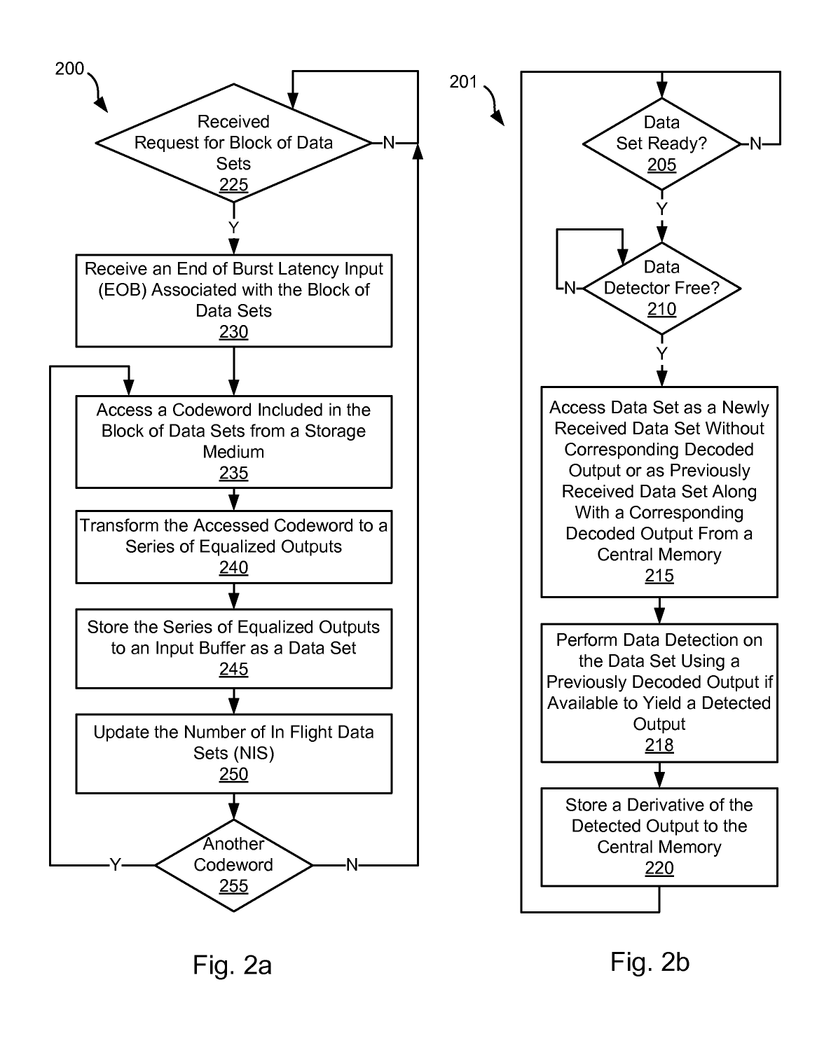

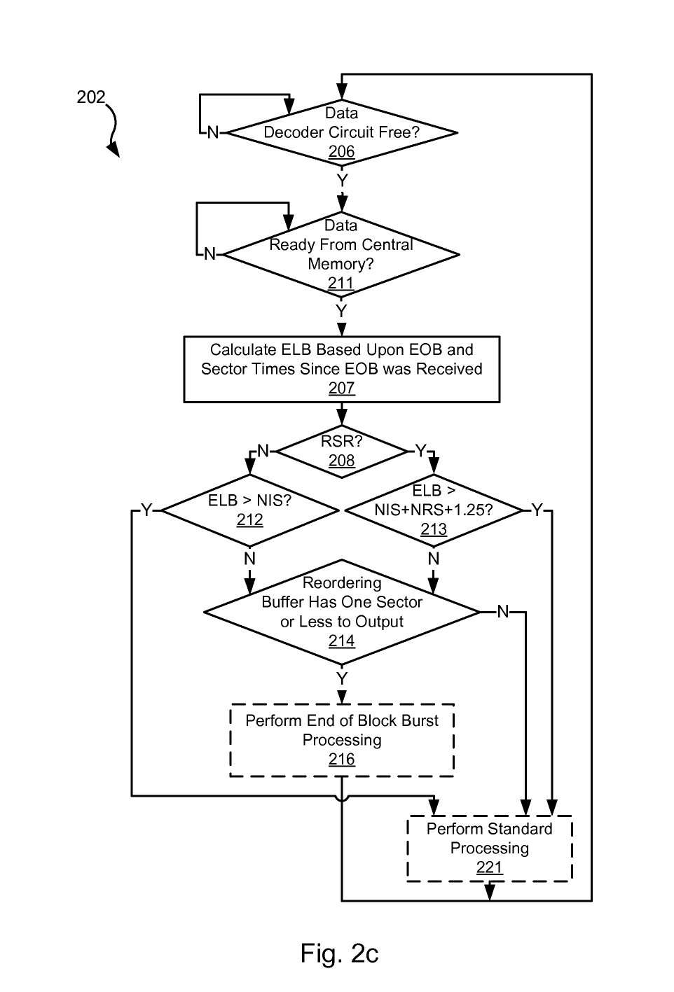

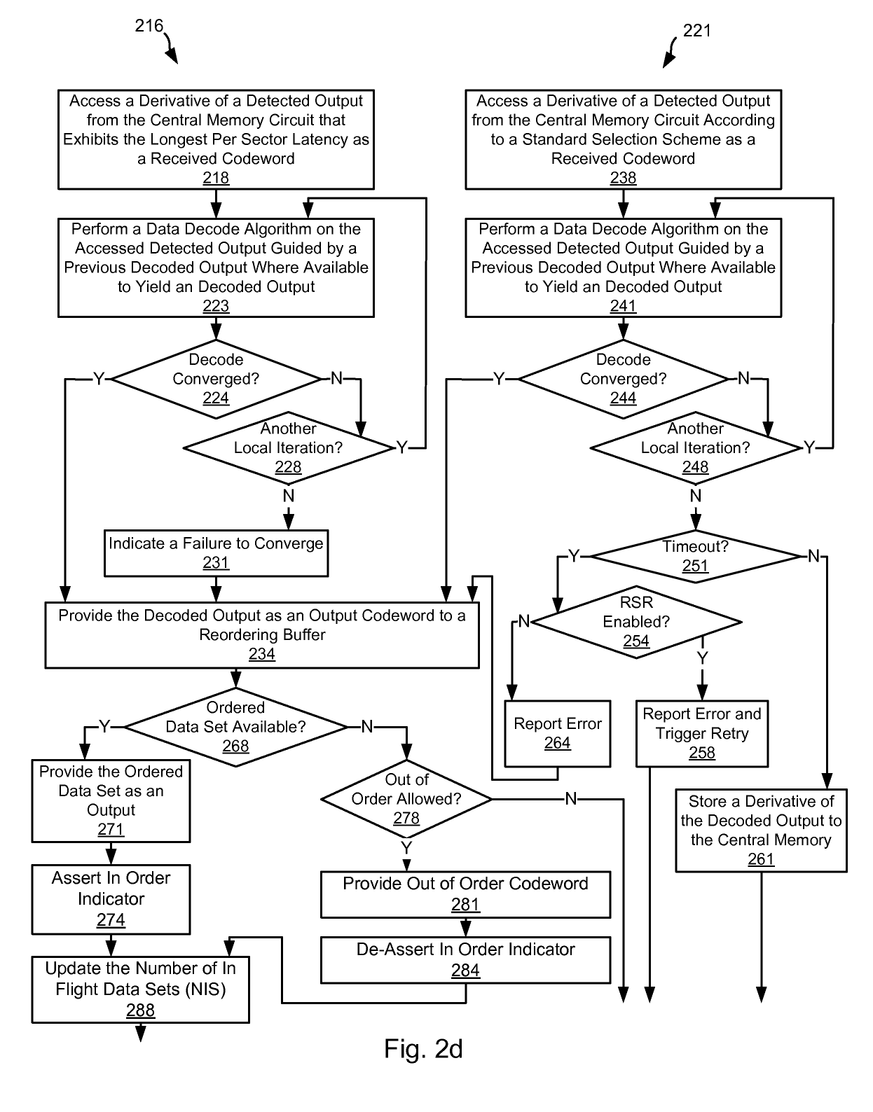

FIGS. 2a-2d are flow diagrams 200, 201, 202 showing a method for data processing including decoder iteration randomization and layered decoding control in accordance with some embodiments of the present invention. Following flow diagram 200 of FIG. 2a, it is determined whether a request is received for a block of data sets from a host controller (block 225). Where a block of data sets have been requested, an end of burst latency input associated with the request for a block of data is received and stored (block 230). A codeword included in the requested block of data sets is accessed from a storage medium (block 235). This accessed data set is transformed into a series of equalized outputs (block 240) that are stored to an input buffer (block 245). The transformation into the series of equalized outputs includes, but is not limited to, conversion into a digital format and equalization of the resulting digital signals. In addition, a number of in flight data sets (NIS) is updated to reflect the introduction of another data set to the input buffer (i.e., NIS is incremented) (block 250). It is then determined whether another codeword remains to be accessed as part of the requested block of data sets (block 255). Where another codeword remains to be accessed (block 255), the processes of blocks 225-255 are repeated.

Turning to FIG. 2b and following flow diagram 201, it is determined whether a data set is ready for application of a data detection algorithm (block 205). In some cases, a data set is ready when it is received from a data decoder circuit via a central memory circuit. In other cases, a data set is ready for processing when it is first made available from a front end processing circuit. Where a data set is ready (block 205), it is determined whether a data detector circuit is available to process the data set (block 210).

Where the data detector circuit is available for processing (block 210), the data set is accessed by the available data detector circuit (block 215). The data detector circuit may be, for example, a Viterbi algorithm data detector circuit or a maximum a posteriori data detector circuit. Where the data set is a newly received data set (i.e., a first global iteration), the newly received data set is accessed. In contrast, where the data set is a previously received data set (i.e., for the second or later global iterations), both the previously received data set and the corresponding decode data available from a preceding global iteration (available from a central memory) is accessed. The accessed data set is then processed by application of a data detection algorithm to the data set (block 218). Where the data set is a newly received data set (i.e., a first global iteration), it is processed without guidance from decode data available from a data decoder circuit. Alternatively, where the data set is a previously received data set (i.e., for the second or later global iterations), it is processed with guidance of corresponding decode data available from preceding global iterations. Application of the data detection algorithm yields a detected output. A derivative of the detected output is stored to the central memory (block 220). The derivative of the detected output may be, for example, an interleaved or shuffled version of the detected output.

Following flow diagram 202 of FIG. 2c, it is determined whether a data decoder circuit is available (block 206) in parallel to the previously described data detection process of FIG. 2b. The data decoder circuit may be, for example, a low density parity check decoding circuit. It is then determined whether a data set is ready from the central memory (block 211). The data set is a derivative of the detected output stored to the central memory as described above in relation to block 220 of FIG. 2b. Where a data set is available in the central memory (block 211), a remaining portion of the EOB budget (again, referred to herein as end of latency budget ELB and is represented in sector times) is calculated (block 207). This may be done by determining the number of sector times that have elapsed since the request for a block of data sets (see block 225 of FIG. 2a).

In addition, it is determined whether retained sector reprocessing is enabled (block 208). Where retained sector reprocessing is not enabled (block 208), retained sectors do not need to be accounted for in determining when to start an end of block burst. In particular, a determination of whether the start of an end of block burst is to begin is made based upon a comparison of the ELB with the NIS (block 212). Alternatively, where retained sector reprocessing is enabled (block 208), retained sectors are accounted for in determining when to start an end of block burst. In particular, a determination of whether the start of an end of block burst is to begin is made based upon a comparison of the ELB with a combination of NIS and the number of retained sectors (NRS) (block 213).

Where retained sector reprocessing is not enabled (block 208) and ELB is less than or equal to NIS (block 212), or where retained sector reprocessing is enabled (block 208) and ELB is less than or equal to NIS+NRS+1.25 (block 213), it is determined whether a reordering buffer (i.e., a buffer responsible for transferring requested data sets to a requesting host) has one sector or less of data remaining to be output (block 214). Where the reordering buffer has one sector or less remaining to be transferred (block 214), end of block burst processing is performed (block 216). Block 216 is shown in dashed lines and more detail of the block is provided as part of flow diagram 216 (i.e., the same number as the block 216) shown in FIG. 2d. Alternatively, where retained sector reprocessing is enabled (block 208) and ELB is greater than NIS (block 212), or where retained sector reprocessing is enabled (block 208) and ELB is greater than NIS+NRS+1.25 (block 213), standard processing is performed (block 221). Block 221 is shown in dashed lines and more detail of the block is provided as part of flow diagram 221 (i.e., the same number as the block 221) shown in FIG. 2d.

Turning to FIG. 2d, where block 216 of FIG. 2c is to be executed, a path along flow diagram 216 is followed. Alternatively, where block 221 of FIG. 2c is to be executed, a path along flow diagram 221 is followed. Following path 216 first, end of block burst processing is performed. This includes accessing a derivative of a detected output from the central memory that exhibits the longest per sector latency of the data sets available in the central memory as a received codeword (block 218). A data decode algorithm is applied to the accessed detected output guided by a previous decoded output where available to yield a decoded output (block 223). Where a previous local iteration has been performed on the received codeword, the results of the previous local iteration (i.e., a previous decoded output) are used to guide application of the decode algorithm. It is then determined whether the decoded output converged (e.g., resulted in the originally written data as indicated by the lack of remaining unsatisfied checks) (block 224).

Where the decoded output converged (block 224), it is provided as a decoded output codeword to a reordering buffer (block 234). It is determined whether the received output codeword is either sequential to a previously reported output codeword in which case reporting the currently received output codeword immediately would be in order, or that the currently received output codeword completes an ordered set of a number of codewords in which case reporting the completed, ordered set of codewords would be in order (block 268). Where the currently received output codeword is either sequential to a previously reported codeword or completes an ordered set of codewords (block 268), the currently received output codeword and, where applicable, other codewords forming an in order sequence of codewords are provided to a recipient as an output (block 271). As the codeword(s) are provided as the output (block 271), an in order indicator is asserted such that the recipient is informed that the transferring codewords are in order (block 274). In addition, the number of in flight data sets (NIS) is updated (block 288). This update includes decrementing NIS to reflect the release of one or more of the previously processing data sets as being output to the requesting host.

Where, on the other hand, the currently received output codeword is not in order or does not render an ordered data set complete (block 268), it is determined whether out of order result reporting is allowed (block 278). This may be determined, for example, by determining whether the value of a maximum queues input is greater than zero. Where out of order result reporting is not allowed (block 278), the process returns back to block 206 of FIG. 2c. Alternatively, where out of order result reporting is allowed (block 278), the currently received output codeword is provided as an output to the recipient (block 281). As the codeword is provided as the output (block 281), in order indicator is de-asserted such that the recipient is informed that the transferring codeword is out of order (block 284). In addition, the number of in flight data sets (NIS) is updated (block 288). This update includes decrementing NIS to reflect the release of the previously processing data sets as being output to the requesting host. At this juncture, the process returns to block 206 of FIG. 2c.

Alternatively, where the decoded output failed to converge (e.g., errors remain) (block 224), it is determined whether another local iteration is desired (block 228). In some embodiments of the present invention, a total of seven local iterations for each global iteration are allowed. Based upon the disclosure provided herein, one of ordinary skill in the art will recognize other numbers of local iterations that may be used in relation to different embodiments of the present invention. Where the current number of local iterations does not exceed the maximum number of local iterations, the another local iteration is desired (block 228) and the processes of blocks 221, 224, 228 are repeated using the results of the previous local iteration as a guide for the next iteration. Otherwise, where the current number of local iterations exceeds the maximum number of local iterations, then another local iteration is not desired (block 228) and a failure is indicated (block 231) and the processes of blocks 268-288 are performed for the non-converging output. Of note, there is no timeout condition such as exceeding a maximum number of allowable global iterations because production of the result directly follows application of the data decode algorithm to assure that end of block burst conditions are met.

Returning to follow path 221, standard processing is performed. This includes accessing a derivative of a detected output from the central memory according to a standard selection algorithm as a received codeword (block 238). The standard selection algorithm may be any approach used in the art to select a data set for addition processing by a data decoder circuit. In some cases, the standard selection may be a first in first out selection or a quality based selection. Based upon the disclosure provided herein, one of ordinary skill in the art will appreciate a variety of selection algorithms that may be used in relation to different embodiments of the present invention. A data decode algorithm is applied to the accessed detected output guided by a previous decoded output where available to yield a decoded output (block 241). Where a previous local iteration has been performed on the received codeword, the results of the previous local iteration (i.e., a previous decoded output) are used to guide application of the decode algorithm. It is then determined whether the decoded output converged (e.g., resulted in the originally written data as indicated by the lack of remaining unsatisfied checks) (block 244).

Where the decoded output converged (block 224), it is provided as a decoded output codeword to a reordering buffer (block 234), and the processes of blocks 268-288 are performed. Otherwise, where the decoded output failed to converge (e.g., errors remain) (block 244), it is determined whether another local iteration is desired (block 248). Again, in some embodiments of the present invention, a total of seven local iterations for each global iteration are allowed. Based upon the disclosure provided herein, one of ordinary skill in the art will recognize other numbers of local iterations that may be used in relation to different embodiments of the present invention. Where the current number of local iterations does not exceed the maximum number of local iterations, the another local iteration is desired (block 248) and the processes of blocks 241, 244, 248 are repeated using the results of the previous local iteration as a guide for the next iteration.

Otherwise, where the current number of local iterations exceeds the maximum number of local iterations, then another local iteration is not desired (block 248). It is determined whether a timeout condition has been met (block 251). The timeout condition may be, but is not limited to, exceeding a maximum number of global iterations for the currently processing data set. Where a timeout condition has been met (block 251), it is determined whether retained sector reprocessing is enabled (block 254). Where retained sector reprocessing is enabled (block 254), an error is reported and a retry is triggered for the currently processing data set (block 258). By triggering the retry, the currently processing data set is retained in the input buffer for reprocessing at a later juncture when processing bandwidth is available. Alternatively, where retained sector reprocessing is not enabled (block 254), an error is reported and the processes of blocks 268-288 are performed. At this juncture, the process returns to block 206 of FIG. 2c.

Alternatively, where a timeout condition has not been met (block 251), a derivative of the decoded output is stored to the central memory to await processing during a subsequent global iteration where both the data detection algorithm and the data decode algorithm are re-applied (block 261). At this juncture, the process returns to block 206 of FIG. 2c.

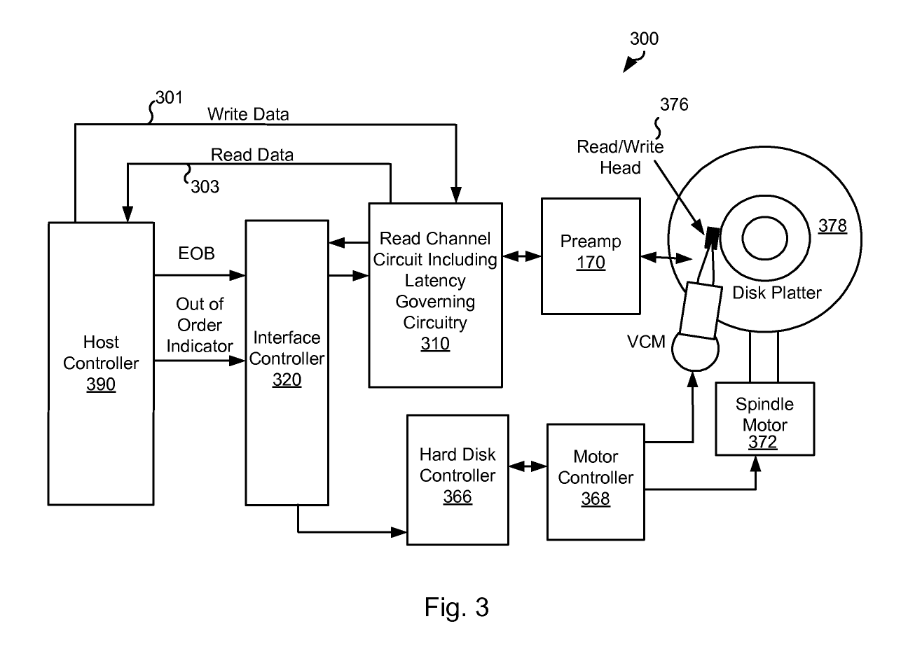

Turning to FIG. 3, a storage system 300 including a read channel circuit 310 having decoder iteration randomization and layered decoding circuitry is shown in accordance with various embodiments of the present invention. Storage system 300 may be, for example, a hard disk drive. Storage system 300 also includes a preamplifier 370, an interface controller 320, a hard disk controller 366, a motor controller 368, a spindle motor 372, a disk platter 378, and a read/write head 376. Interface controller 320 controls addressing and timing of data to/from disk platter 378, and interacts with a host controller 390 that requests blocks of data to be accessed from disk platter 378, and receives the requested data. As part of requesting the data, host controller 390 provides an end of buffer latency input (EOB), and an out of order indicator. The end of buffer latency input indicates a maximum latency from the time the last data set in a requested block of data is accessed from disk platter 378 until it is provided as write data 301 to host controller 390. The out of order indicator indicates whether data can be accepted by host controller 390 in an order different from its location within the sequence of the requested block. The data on disk platter 378 consists of groups of magnetic signals that may be detected by read/write head assembly 376 when the assembly is properly positioned over disk platter 378. In one embodiment, disk platter 378 includes magnetic signals recorded in accordance with either a longitudinal or a perpendicular recording scheme.

In a typical read operation, read/write head assembly 376 is accurately positioned by motor controller 368 over a desired data track on disk platter 378. Motor controller 368 both positions read/write head assembly 376 in relation to disk platter 378 and drives spindle motor 372 by moving read/write head assembly to the proper data track on disk platter 378 under the direction of hard disk controller 366. Spindle motor 372 spins disk platter 378 at a determined spin rate (RPMs). Once read/write head assembly 376 is positioned adjacent the proper data track, magnetic signals representing data on disk platter 378 are sensed by read/write head assembly 376 as disk platter 378 is rotated by spindle motor 372. The sensed magnetic signals are provided as a continuous, minute analog signal representative of the magnetic data on disk platter 378. This minute analog signal is transferred from read/write head assembly 376 to read channel circuit 310 via preamplifier 370. Preamplifier 370 is operable to amplify the minute analog signals accessed from disk platter 378. In turn, read channel circuit 310 decodes and digitizes the received analog signal to recreate the information originally written to disk platter 378. This data is provided as read data 303 to a receiving circuit. A write operation is substantially the opposite of the preceding read operation with write data 301 being provided to read channel circuit 310. This data is then encoded and written to disk platter 378.

As part of processing the received information, read channel circuit 310 applies a varying number of global iterations and local iterations to the received information. Read channel circuit 310 operates to assure that the last data set provided that corresponds to a requested block of data is provided to host controller 390 within a time period defined by EOB. This is done while assuring that data is not idled awaiting output as write data 301, but is available for more local iterations through a data decoder circuit included in read channel circuit to increase a likelihood that the data set will converge. In some cases, read channel circuit 310 may be implemented to include a data processing circuit similar to that discussed above in relation to FIGS. 1a-1c. Further, the data processing implemented by read channel circuit 310 may be implemented similar to that discussed above in relation to FIGS. 2a-2c.

It should be noted that storage system 300 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 300, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 310 may be, but is not limited to, a low density parity check (LDPC) decoder circuit as are known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In addition, it should be noted that storage system 300 may be modified to include solid state memory that is used to store data in addition to the storage offered by disk platter 378. This solid state memory may be used in parallel to disk platter 378 to provide additional storage. In such a case, the solid state memory receives and provides information directly to read channel circuit 310. Alternatively, the solid state memory may be used as a cache where it offers faster access time than that offered by disk platted 378. In such a case, the solid state memory may be disposed between interface controller 320 and read channel circuit 310 where it operates as a pass through to disk platter 378 when requested data is not available in the solid state memory or when the solid state memory does not have sufficient storage to hold a newly written data set. Based upon the disclosure provided herein, one of ordinary skill in the art will recognize a variety of storage systems including both disk platter 378 and a solid state memory.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for data processing, the method comprising:
receiving a request for a block of data sets, wherein the block of data sets includes at least a first data set and a second data set;
storing the first data set to an input buffer;
storing the second data set to the input buffer;
determining a remaining portion (ELB) of an end of burst latency (EOB) allowable for processing the block of data sets;
scheduling processing of the first data set by a data processing circuit according to a first scheduling algorithm based at least in part on the ELB being less than a threshold; and
scheduling processing of the first data set by the data processing circuit according to a second scheduling algorithm when the ELB is greater than the threshold.

2. The method of claim 1, wherein the threshold is a first threshold, wherein the ELB is a first ELB, and wherein the method further comprises:
determining a second ELB of the EOB;
scheduling processing of the second data set by the data processing circuit according to the first scheduling algorithm when the second ELB is less than a second threshold; and
scheduling processing of the first data set by the data processing circuit according to a second scheduling algorithm when the second ELB is greater than the second threshold.

3. The method of claim 1, wherein the method further comprises:
accessing a representation of the first data set from a storage medium;
accessing a representation of the second data set from the storage medium; and
wherein a first period required to access the first data set from the storage medium is a sector time, and wherein a second period required to access the second data set from the storage medium is the sector time.

4. The method of claim 3, wherein determining the ELB is done by subtracting a number of sector times passed from when the first data set is accessed from the storage medium from the EOB.

5. The method of claim 1, wherein the threshold is a number of data sets maintained in the input buffer.

6. The method of claim 1, wherein the threshold is the aggregate of a number of data sets maintained in the input buffer being initially processed through the data processing circuit and a number of data sets maintained in the input buffer awaiting retry processing through the data processing circuit plus a fixed amount.

7. The method of claim 6, wherein the data processing circuit includes:
a data detector circuit operable to apply a data detection algorithm to yield a detected output; and
a data decoder circuit operable to apply a data decode algorithm to a decoder input derived from the detected output.

8. The method of claim 7, wherein the first scheduling algorithm terminates processing of the first data set upon completion of application of the data decode algorithm regardless of whether another iteration through both the data detector circuit and data decoder circuit would be allowed for the first data set if the second scheduling algorithm was used for scheduling.

9. The method of claim 1, wherein scheduling processing of the first data set by a data processing circuit according to the first scheduling algorithm is done when the ELB is less than the threshold and an output buffer is ready to transfer a data set to a requester.

10. A system for data processing, the system comprising:
an input buffer operable to maintain a first data set and a second data set;
a data detector circuit operable to:
apply a data detection algorithm to the first data set to yield a first detected output, and
apply the data detection algorithm to the second data set to yield a second detected output;
a data decoder circuit operable to:
apply a data decode algorithm to a first decoder input derived from the first detected output to yield a first decoder output, and
apply the data decode algorithm to a second decoder input derived from the second detected output to yield a second decoder output;
a scheduling circuit operable to:
determine a remaining portion (ELB) of an end of burst latency value;
scheduling processing of the first data set by the data decoder circuit according to a first scheduling algorithm based at least in part on the ELB being less than a threshold; and
scheduling processing of the first data set by the data decoder circuit according to a second scheduling algorithm when the ELB is greater than the threshold.

11. The system of claim 10, wherein the system is implemented as part of a data storage device, and wherein the system further comprises:
a storage medium maintaining a representation of the first data set and the second data set;
an access circuit operable to:
access the representation of the first data set and the representation of the second data set from the storage medium,
store the first data set and the second data set to the input buffer;
wherein a first period required to access the representation of the first data set from the storage medium is a sector time, and wherein a second period required to access the representation of the second data set from the storage medium is the sector time; and
wherein the end of burst latency value is a maximum number of sector times allowable from when a last portion of a data block is accessed from the storage medium until the last portion is provided as an output, wherein the data block includes both the first data set and the second data set.

12. The system of claim 11, wherein determining the ELB is done by subtracting a number of sector times passed from when the representation of the first data set is accessed from the storage medium from the end of burst latency value.

13. The system of claim 10, wherein the threshold is a number of data sets maintained in the input buffer.

14. The system of claim 10, wherein the threshold is the aggregate of a number of data sets maintained in the input buffer being initially processed through the data processing circuit and a number of data sets maintained in the input buffer awaiting retry processing through the data processing circuit plus a fixed amount.

15. The system of claim 14, wherein the first scheduling algorithm terminates processing of the first data set upon completion of application of the data decode algorithm regardless of whether another iteration through both the data detector circuit and data decoder circuit would be allowed for the first data set if the second scheduling algorithm was used for scheduling.

16. The system of claim 14, wherein the data decoder is operable to process four data sets per sector time, and wherein the fixed amount is 1.25.

17. The system of claim 10, wherein the system is implemented as part of an integrated circuit.

18. The system of claim 10, wherein the system further comprises:
an output buffer operable to transfer a result from the data decoder circuit to a recipient; and
wherein scheduling processing of the first data set by a data processing circuit according to the first scheduling algorithm is done when the ELB is less than the threshold and the output buffer has one or fewer results from the decoder circuit awaiting transfer to the recipient.

19. A data storage device, the storage device comprising:
a storage medium, wherein the storage medium includes at least a representation of a first data set and a representation of a second data set;
a head assembly disposed in relation to the storage medium and operable to provide a first sensed signal corresponding to the representation of the first data set and a second senses signal corresponding to the representation of the second data set;
a read channel circuit including:
an analog front end circuit operable to provide a first analog signal corresponding to the first sensed signal and a second analog signal corresponding to the second sensed signal;
an analog to digital converter circuit operable to sample the first analog signal to yield a first series of digital samples and to sample the second analog signal to yield a second series of digital samples;
an equalizer circuit operable to equalize the first series of digital samples to yield a first data set and to equalize the second series of digital samples to yield a second data set;
an input buffer operable to maintain a first data set and a second data set;
a data detector circuit operable to:
apply a data detection algorithm to the first data set to yield a first detected output, and
apply the data detection algorithm to the second data set to yield a second detected output;
a data decoder circuit operable to:
apply a data decode algorithm to a first decoder input derived from the first detected output to yield a first decoder output, and
apply the data decode algorithm to a second decoder input derived from the second detected output to yield a second decoder output;
a scheduling circuit operable to:
determine a remaining portion (ELB) of an end of burst latency value;
scheduling processing of the first data set by the data decoder circuit according to a first scheduling algorithm based at least in part on the ELB being less than a threshold; and
scheduling processing of the first data set by the data decoder circuit according to a second scheduling algorithm when the ELB is greater than the threshold.

20. The storage device of claim 19, wherein:
a first period required to access the representation of the first data set from the storage medium is a sector time, and wherein a second period required to access the representation of the second data set from the storage medium is the sector time; and
wherein the end of burst latency value is a maximum number of sector times allowable from when a last portion of a data block is accessed from the storage medium until the last portion is provided as an output, wherein the data block includes both the first data set and the second data set.
